(19) United States
(12) Patent Application Publication
(10) Pub. No.: US 2002/0111924 A1
(43) Pub. Date: Aug. 15, 2002

(54) Fuel dispensing system utilizing XML processors

(75) Inventor: Tommy W. Lewis, Chesapeake, VA (US)

Correspondence Address: RANDALL J. KNUTH P.C., 3510-A STELLHORN ROAD, FORT WAYNE, IN, 46815-4631, US

(73) Assignee: Tokheim Corporation

(21) Appl. No.: 09/976,803

(22) Filed: Oct. 11, 2001

Related U.S. Application Data
(60) Provisional application No. 60/248,445, filed on Nov. 14, 2000.

(51) Int. Cl. G06F 17/00; B67D 5/00

(52) U.S. Cl. 705/413

(57) ABSTRACT

A fuel dispenser environment includes multiple dispenser positions each configured with at least one application module configured to perform various dispenser and transaction related functions. Each application module includes at least one processor configured with an Extensible Markup Language (XML) signal processing capability enabling it to perform various processing tasks. The XML processor can process input data objects acquired from the fuel dispenser environment and generate corresponding XML documents that incorporate the input data. These XML files may be exchanged with other local applications or communicated over a network connection to a remote server application. The XML processor can also process input XML documents and retrieve the data objects contained therein. These retrieved data objects may then be used as inputs to the fuel dispenser environment. In particular, these data objects are provided in a native format compatible with the dispenser devices. The input XML documents may be provided by a local or remote source, such as an Internet server.

### BACKGROUND OF THE INVENTION

1. Field of the Invention

The present invention relates to a refueling system, and, more particularly, to a fuel dispenser environment configured to include application modules having processors with Extensible Markup Language (XML) signal processing capabilities, thereby facilitating the description, communication, manipulation, and presentation of structured data within and in conjunction with the refueling environment.

2. Description of the Related Art

Since the introduction of the first electronic fuel dispenser, devices in the fueling environment have been handling structured data. The amount of data initially existing in the fueling environment was limited to items such as configuration parameters and meter totals. As the capabilities of these devices have increased, the amount of data required to support these devices has grown commensurately. In addition, the requirements of customers and consumers have caused a vast increase in the amount of data required in the fueling environment.

As the amount of structured data has increased, the number of ways in which it can be described, communicated, manipulated, and presented has also risen. For example, reports require the data to be sorted, filtered, and presented. Additionally, device interfaces require the communication of data.

Devices in the fueling environment must have the capability of processing structured data. The processing demands for devices increase with the number of different methods of describing, manipulating, presenting, and communicating data.

What is therefore needed is a standardized method of processing data to reduce the processing requirements for the refueling system.

### SUMMARY OF THE INVENTION

According to the present invention there is provided a method and system for use in combination with a fuel dispenser environment having multiple dispenser positions. The dispenser environment is adapted, modified, or otherwise configured to include a functionality that enables data operations and other such signal processing involving Extensible Markup Language (XML) signal formats.

In one form, the dispenser environment includes at least one application module having at least one XML processor. The application module includes any number of application programs and utilities that perform various functions and operations in relation to the dispenser environment. In one configuration, the application module and XML processors are implemented in the form of a computing platform such as a microprocessor in combination with a storage facility having the various software-based application programs.

The XML processors can perform any number of various data processing functions and operations. For example, according to one type of formatting function, the XML processor can transform non-XML data objects into XML documents. These non-XML data objects may correspond to signals provided by the various components, devices, and processes of the dispenser environment.

In one case, signals are transformed from the native format of the host device into an XML document suitable for use by an XML-compatible application. This transformation may be considered an encoding function in which the native format signals are encoded into an XML document containing a data object representation of the signals. In effect, the native format signals serve (at least in part) as content elements of the XML document.

Furthermore, according to another type of formatting function, XML documents generated by an application program or otherwise furnished to the XML processor are transformed into multiple data objects representative of the data content of the XML document. These data objects are provided in a form native to the target device, namely, a format suitable for use or otherwise compatible with the target device. This transformation may be considered a decoding operation in which signals expressed at least in part in an XML format (e.g., an XML document) are decoded into their corresponding content data elements.

Other XML processor operations include, but are not limited to, a validating function, a transforming function, a rendering function, and a transporting function. However, this recitation of XML processor functions is simply illustrative and should not be considered in limitation of the present invention, as it should be apparent that the XML processors described herein can encompass any XML-related operation or processing task.

By way of illustration, and not in limitation of the present invention, the signals subject to processing by the XML processor include signals issuing from the fuel dispenser environment and/or signals issuing to the fuel dispenser environment. This description of signals illustrates the various types of signals that may be present within the refueling environment. These signals include those not expressed in XML and those expressed at least in part in XML.

As used herein, signals that issue from the refueling environment may be understood as encompassing (without limitation) signals present within the refueling environment that are being provided for use by: (i) another component within the refueling environment, (ii) a component outside the immediate refueling position but still within the confines of the refueling station, and/or (iii) a device remote from the refueling station (i.e., outside the refueling environment).

Similarly, as used herein, signals that issue to the refueling environment may be understood as encompassing (without limitation) signals that are being provided for use by a device within the refueling environment and that are being provided from: (i) another component within the refueling environment, (ii) a component outside the immediate refueling position but still within the confines of the refueling station, and/or (iii) a device remote from the refueling station (i.e., outside the refueling environment).

For example, a signal exchange between components within the refueling environment may include local communications such as the transfer of a signal generated by the fuel pump to a printer (e.g., transmitting an indication of the dispensed fuel volume). Such data exchanges may take place between individual components of a corresponding refueling position or between individual components belonging to different fuel dispensing positions within the refueling environment.

Additionally, communications between a component within the refueling environment and a component outside the immediate refueling position (but still within the confines of the refueling station) may include bi-directional transmissions between a fuel dispenser device and a device resident within an on-site facility or attached to a local area network. For example, the transaction selections made by a customer via an appropriate input device may be forwarded to an on-site central operator terminal or transferred to a router via a LAN connection for further uploading to a remote asset management system.

Furthermore, communications between a component within the fuel dispensing environment and a component outside the refueling station (such as a remote facility) may include, but are not limited to, (1) monitoring data uploaded by an on-site controller to a remote management facility over a suitable network link; (2) software downloads from a remote facility to the various computing and processing platforms within the refueling environment (e.g., browser updates, interface and driver routine updates, operating system updates); (3) transaction requests submitted by the customer to the remote facility; and (4) response signals transmitted by the remote facility to the onsite dispenser controller (e.g., commands and other control signals for executing and otherwise carrying out the requested refueling operation).

It is a preferred feature of the present invention that configuring or otherwise implementing the dispenser environment with an XML processing facility enables the dispenser environment to communicate with other entities and facilities that have XML compliant devices, processes, and data. For example, Internet applications and servers that communicate, handle, and otherwise manipulate information in XML can readily exchange information with the dispenser environment constructed according to the present invention.

It is also a feature of the present invention that the activities conducted between the dispenser environment and a remote management facility may be carried out and otherwise executed using XML-based signals. In particular, XML will serve (at least in part) as the specification standard that defines the manner in which signals are represented, for purposes of making them available for transfer and further processing. For this purpose, the remote facility would be equipped with an appropriate XML processing facility that is functionally similar to that deployed at the dispenser environment.

As used herein, a device, component, module, or equivalent recitation thereof should be understood as encompassing, without limitation, any means, facility, or functionality implemented in hardware, software, firmware, logic circuitry, program code, data, or any combination thereof. Additionally, as used herein, a process may embody any one of the preceding elements alone or in combination with one another.

Accordingly, the present invention may apply to the exchange of data that occurs, for example, between the following elements: (1) discrete physical entities (e.g., a workstation, processor, or controller and a peripheral device); (2) software processes or applications resident on the same or different computing platform (e.g., a communication between a report generating word processor and a browser); (3) addresses in memory along a communications bus; (4) various data structures (e.g., the transfer of data between databases); and (5) peripheral objects (e.g., the transfer of data involving an audio/video apparatus and a recording machine over a bus or network).

Furthermore, the issuance of a signal should be understood as encompassing (without limitation) any of the various types of signal communications, exchanges, or transfers noted above. For example, a data exchange taking place between various software applications resident on the same computing platform would constitute the issuance of a signal. Accordingly, it should be apparent that for the issuance of a signal to take place, the signal need not move beyond the machine, medium, or physical object where the signal is present.

Other types of signal issuing activity include, but are not limited to, (1) communications between a software process and at least one of a database, a communication means (e.g., network connection), hardware, and/or another software process; (2) exchanges between communications apparatus (e.g., a router and a switch); (3) communications between objects within the same computing platform (e.g., a microprocessor and display apparatus); and (4) communications between objects with different platforms (e.g., a central controller and a dedicated workstation browser).

As used herein, a signal should be understood as encompassing, without limitation, a signal conveyed by any means such as optical, wireless, RF, fixed line, or any combination thereof. Additionally, the types of signals may include, without limitation, control signals, commands, and data or information such as text, audio, video, image, and graphics. Additionally, the information may occur in any form such as analog or digital.

A refueling environment that supports XML processing and communications is thus able to take advantage of the XML vocabulary and supporting technologies in connection with describing, representing, or otherwise expressing (in whole or in part) the signals that are present within the refueling environment or otherwise associated with the refueling operation.

The use of XML processors should broadly be understood as pertaining to signals used in conjunction with various operations, tasks, and other activities carried out in the refueling environment that include, but are not limited to, data exchange, communication, transfer, processing, manipulation, and presentation.

The invention, in one form thereof, is directed to a system comprising, in combination, at least one processor and a refueling system including at least one fuel dispenser environment. Each processor is associated with a respective fuel dispenser environment and has an Extensible Markup Language (XML) signal processing capability.

The system, in one form, further includes at least one application module each associated with a respective fuel dispenser environment. Each application module is cooperatively associated with at least one of the processors of the fuel dispenser environment associated therewith. Additionally, each application module is configured to operatively perform at least one application function in relation to the fuel dispenser environment associated therewith.

In another form, each processor further includes an encoder process and/or a decoder process. The encoder process is configured to encode at least one input signal received from the respective fuel dispenser environment associated therewith into at least one output XML document. The decoder process is configured to decode at least one input XML document and produce therefrom at least one output signal representative of at least one data signal embodied within the at least one input XML document. At least one of the output signals is readable by the respective fuel dispenser environment associated therewith.

The system, in another form, further includes at least one network connection. Each network connection is associated with a respective fuel dispenser environment. Moreover, each network connection is configured for operative communication with at least one respective processor of the respective fuel dispenser environment.

The system further includes a network arranged in operative communication with the refueling system. In one form, the network includes the Internet.

In yet another form of the system, the XML signal processing capability of each respective processor enables the performance of various processing functions. For example, one processing function involves, inter alia, receiving at least one input data object from the respective fuel dispenser environment associated therewith, and then expressing the input data objects as at least one output XML document. Another processing function involves, inter alia, receiving at least one input XML document, and then processing the input XML documents to provide at least one output data object derived therefrom. At least one of the output data objects is readable by the respective fuel dispenser environment associated therewith.

The input data objects associated with a respective fuel dispenser environment comprise, in one form thereof, signals including at least one of operational information, configuration information, status information, diagnostic information, refueling transaction information, financial information, and point-of-sale (POS) information.

In one specific form, the input data objects associated with a respective fuel dispenser environment comprise signals generated by at least one of a dispenser controller, fuel pump assembly, fuel metering device, vapor recovery assembly, user input device, display assembly, card reader, printer, fuel monitoring equipment, audio apparatus, video apparatus, and communications apparatus.

The output data objects associated with a respective fuel dispenser environment comprise, in one form thereof, signals including at least one of commands, operating instructions, control information, reconfiguration information, authorization information, sale information, and program code downloads.

In one specific form, the output data objects associated with a respective fuel dispenser environment comprise signals readable by at least one of a dispenser controller, fuel pump assembly, fuel metering device, vapor recovery assembly, user input device, display assembly, card reader, printer, fuel monitoring equipment, audio apparatus, video apparatus, and communications apparatus.

The invention, in another form thereof, is directed to a system comprising, in combination, at least one application module and at least one fuel dispenser environment. Each application module is associated with a respective fuel dispenser environment. Additionally, each application module includes at least one processor each having an Extensible Markup Language (XML) signal processing capability.

Each processor, in one form thereof, includes an encoder process and/or a decoder process. The encoder process is configured to encode at least one input signal received from the respective fuel dispenser environment associated therewith into at least one output XML document. The decoder process is configured to decode at least one input XML document and produce therefrom at least one output signal representative of at least one data signal embodied within the at least one input XML document. At least one of the output signals is readable by the respective fuel dispenser environment associated therewith.

Each application module, in one form thereof, is configured to operatively perform at least one application function in relation to the fuel dispenser environment associated therewith. In a preferred form, each application module is operable to perform the application functions associated therewith using data objects derived from XML documents and/or signals having an XML format, as provided by the XML processor(s) associated with the application module.

The input signals associated with a respective fuel dispenser environment comprise, in one form thereof, signals including at least one of operational information, configuration information, status information, diagnostic information, refueling transaction information, financial information, and point-of-sale (POS) information.

In one specific form, the input signals associated with a respective fuel dispenser environment include signals generated by at least one of a dispenser controller, fuel pump assembly, fuel metering device, vapor recovery assembly, user input device, display assembly, card reader, printer, fuel monitoring equipment, audio apparatus, video apparatus, and communications apparatus.

The output signals associated with a respective fuel dispenser environment comprise, in one form thereof, signals including at least one of commands, operating instructions, control information, reconfiguration information, authorization information, sale information, and program code downloads.

In one specific form, the output signals associated with a respective fuel dispenser environment include signals readable by at least one of a dispenser controller, fuel pump assembly, fuel metering device, vapor recovery assembly, user input device, display assembly, card reader, printer, fuel monitoring equipment, audio apparatus, video apparatus, and communications apparatus.

In another form of the system, the XML signal processing capability of each respective processor enables the performance of various processing functions. For example, one processing function involves, inter alia, receiving at least one first input signal from the respective fuel dispenser environment associated therewith, and expressing the at least one first input signal as at least one first output signal provided at least in part in an XML format. Another processing function involves, inter alia, receiving at least one second input signal expressed at least in part in an XML format, and processing the at least one second input signal to provide at least one second output signal derived therefrom. At least one of the second output signals is readable by the respective fuel dispenser environment associated therewith.

The system, in another form thereof, further includes at least one network connection each associated with a respective fuel dispenser environment. Each network connection is configured for operative communication with at least one respective application module of the respective fuel dispenser environment.

Additionally, the system includes a network arranged in operative communication with the respective network connection of at least one fuel dispenser environment.

The invention, in another form thereof, is directed to an apparatus comprising, in combination, at least one Extensible Markup Language (XML) processor and at least one fuel dispenser environment. Each XML processor is associated with a respective fuel dispenser environment.

In one form, each XML processor includes a data object encoder process and/or an XML document decoder process. At least one of the decoded signals produced by the XML document decoder process is readable by the respective fuel dispenser environment associated therewith.

In another form, each XML processor a first data process and/or a second data process. The first data process is configured to provide at least one output signal in an XML format, using at least one signal received from the respective fuel dispenser environment associated therewith. The second data process is configured to process at least one input signal having an XML format and provide at least one output signal derived therefrom. At least one of the output signals provided by the second data process is compatible with the respective fuel dispenser environment associated therewith.

The apparatus further includes at least one network connection each associated with a respective fuel dispenser environment. Each network connection is configured for operative communication with at least one respective XML processor of the respective fuel dispenser environment.

The invention, in another form thereof, is directed to an apparatus comprising, in combination, at least one application module and at least one fuel dispenser environment. Each application module is associated with a respective fuel dispenser environment. Each application module includes at least one Extensible Markup Language (XML) processor.

In one form, each XML processor includes a data object encoder process and/or an XML document decoder process. At least one of the decoded signals produced by the XML document decoder process is compatible with the respective fuel dispenser environment associated therewith.

Each application module is configured to operatively perform at least one application function in relation to the fuel dispenser environment associated therewith.

The invention, in another form thereof, is directed to a system comprising, in combination, at least one processor and at least one fuel dispenser environment. Each processor is associated with a respective fuel dispenser environment. Each processor may include a data process configured to provide at least one output Extensible Markup Language (XML) document, using at least one input signal received from the respective fuel dispenser environment associated therewith. Additionally, each processor may include a data process configured to process at least one input XML document and provide at least one output signal derived therefrom, wherein at least one of the output signals is readable by the respective fuel dispenser environment associated therewith.

The invention, in another form thereof, is directed to a system comprising, in combination, at least one processor means and at least one fuel dispenser environment. Each processor means is associated with a respective fuel dispenser environment. Each processor means may include a means, which is responsive to at least one input signal received from the respective fuel dispenser environment associated therewith, for generating at least one Extensible Markup Language (XML) document, using the at least one input signal as content. Each processor means may also include a means, which is responsive to at least one input XML document, for processing the at least one input XML document to produce at least one output signal derived therefrom, wherein at least one of the output signals is readable by the respective fuel dispenser environment associated therewith.

The invention, in another form thereof, is directed to a system comprising, in combination, at least one processor and at least one fuel dispenser environment. Each processor is associated with a respective fuel dispenser environment. Each processor includes a first data process and/or a second data process. The first data process is configured to provide at least one output signal expressed at least in part in an Extensible Markup Language (XML) format, using at least one signal received from the respective fuel dispenser environment associated therewith. The second data process is configured to process at least one input signal expressed at least in part in an XML format and to provide at least one output signal derived therefrom, wherein at least one of the output signals provided by the second data process is readable by the respective fuel dispenser environment associated therewith.

The invention, in another form thereof, is directed to a system comprising, in combination, at least one fuel dispenser environment and at least one processor each associated with a respective fuel dispenser environment. Each processor includes an encoder process and a decoder process. The encoder process is configured to encode at least one input signal received from the respective fuel dispenser environment associated therewith into at least one output Extensible Markup Language (XML) document. The decoder process is configured to decode at least one input XML document and provide at least one output signal derived therefrom, wherein at least one of the output signals is readable by the respective fuel dispenser environment associated therewith.

The invention, in another form thereof, is directed to a system comprising, in combination, at least one fuel dispenser environment and at least one processor each associated with a respective fuel dispenser environment. Each processor includes a means, which is responsive to at least one input signal received from the respective fuel dispenser environment associated therewith, for encoding the at least one input signal into at least one Extensible Markup Language (XML) document. Each processor further includes a means, which is responsive to at least one input XML document, for decoding the at least one input XML document to produce at least one output signal derived therefrom, wherein at least one of the output signals is readable by the respective fuel dispenser environment associated therewith.

The invention, in another form thereof, is directed to a system comprising, in combination, at least one fuel dispenser environment and at least one processor each associated with a respective fuel dispenser environment. Each processor includes an encoder process and a decoder process. The encoder process is configured to encode at least one signal received from the respective fuel dispenser environment associated therewith into at least one output signal expressed at least in part in an Extensible Markup Language (XML) format. The decoder process is configured to decode at least one input signal expressed at least in part in an XML format and provide at least one output signal derived therefrom, wherein at least one of the output signals provided by the second data process is readable by the respective fuel dispenser environment associated therewith.

The invention, in yet another form thereof, is directed to a method for use in a fuel dispenser environment. The method involves various operations including, inter alia, receiving at least one input signal issuing from the fuel dispenser environment; processing the input signals to generate at least one Extensible Markup Language (XML) document incorporating the input signals; receiving at least one input XML document; and processing the input XML documents to provide at least one output signal representative of at least one signal embodied within the input XML documents. At least one of the output signals provided by the input XML document processing operation is readable by the fuel dispenser environment.

The method, in one form thereof, further includes the steps of providing at least one application process, wherein each application process is configured to operatively perform at least one application function in relation to the fuel dispenser environment; and executing at least one application function, using at least one output signal provided by the input XML document processing step.

The invention, in yet another form thereof, is directed to a method for use in a fuel dispenser environment. The method involves various operations including, inter alia, encoding at least one input signal issuing from the fuel dispenser environment into at least one Extensible Markup Language (XML) document; and decoding at least one input XML document to produce at least one output signal representative of at least one data signal embodied within the input XML documents. At least one of output signals produced by the decoding operation is readable by the fuel dispenser environment.

The method, in one form thereof, further includes the steps of providing at least one application process, wherein each application process is configured to operatively perform at least one application function in relation to the fuel dispenser environment; and executing at least one application function, using at least one output signal provided by the decoding operation.

The invention, in still yet another form thereof, is directed to a system comprising, in combination, at least one fuel dispenser environment, each fuel dispenser environment including at least one device; and at least one Extensible Markup Language (XML) processor, each XML processor being associated with a respective fuel dispenser environment device.

The invention, in still yet another form thereof, is directed to a system comprising, in combination, at least one fuel dispenser environment, each fuel dispenser environment including at least one device; and at least one application module, each application module being associated with a respective fuel dispenser environment device. Each application module includes at least one Extensible Markup Language (XML) processor.

One advantage of the present invention is that by configuring the fuel dispensing environment to include at least one application module each having at least one processor capable of performing Extensible Markup Language signal processing functions, there is developed a common standard for signal description that enhances interoperability and interaction among the various dispenser site devices, which otherwise have disparate and incompatible formats and protocols.

Another advantage of the present invention is that the XML processors allow remote server applications to readily access the refueling environment over an Internet connection.

A further advantage of the invention is that the description of dispenser-related information into an XML format provides the refueling environment with the opportunity to exploit the various emerging applications and technologies that are based upon XML data constructions.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram illustration of a network arrangement that interconnects various fuel dispenser environments each incorporating the present invention;

FIG. 2 is a block diagram illustration of one embodiment of the present invention, showing the use of a central XML processing facility to handle the XML processing tasks of the entire fuel dispenser location as part of a centralized XML computing environment;

FIG. 3 is a block diagram illustration of another embodiment of the present invention, showing the use of a dedicated XML processing module deployed within each fuel dispenser position as part of a distributed XML computing environment;

FIG. 4 is a block diagram illustration of one typical configuration for the fuel dispenser position of FIG. 3, showing the interrelationship between the dedicated XML processing module and the local devices resident at the dispenser position; and

FIGS. 5A and 5B are diagrammatic representations illustrating the operational features of a formatting function performed by an XML processor, according to the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

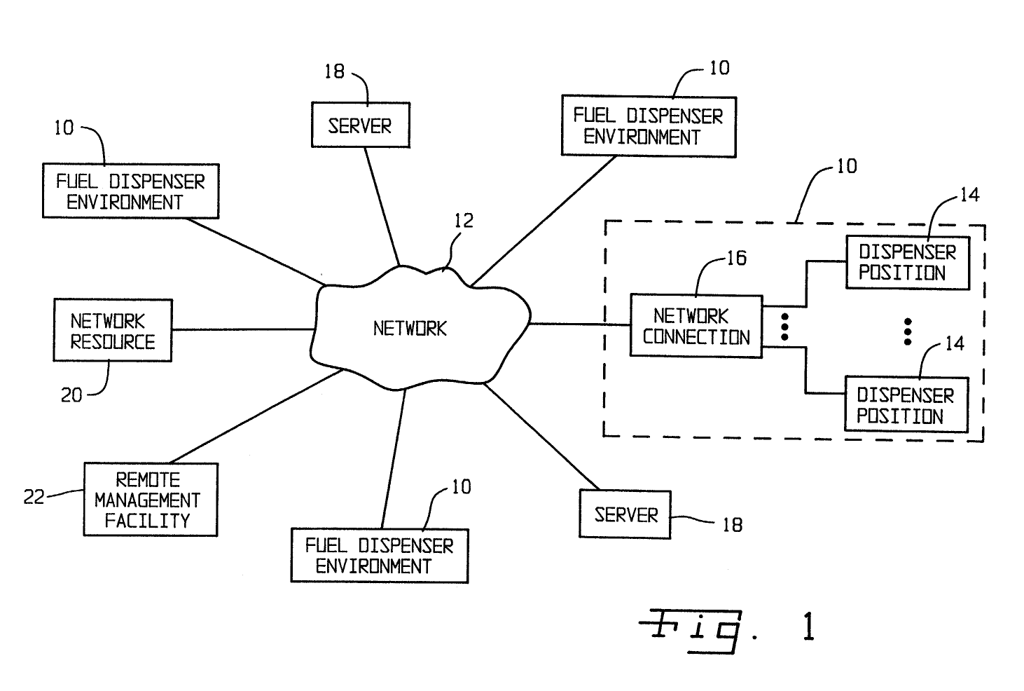

By way of introduction, reference is first made to FIG. 1 to describe the system architecture within which the present invention is deployed, according to one illustrative form thereof. FIG. 1 depicts a system view of a networked arrangement for interconnecting a plurality of individual fuel dispenser environments 10 using a network 12.

As discussed further, and in accordance with the present invention, each fuel dispenser environment 10 incorporates at least one application module each having at least one processing module capable of performing various Extensible Markup Language (XML) signal processing tasks. The application module may include, but is not limited to, application programs that perform various dispenser-related and transaction-related functions.

Referring still to FIG. 1, each fuel dispenser environment 10 encompasses a refueling site or location that includes a plurality of individual fuel dispenser positions 14 each capable of servicing a refueling customer or other such user. The fuel dispensing environment 10 preferably encompasses the entire service station architecture, such as an arrangement in which the refueling positions 14 are linked over a local area network (LAN) to a station operator terminal or an on-site convenience store (e.g., an affiliated facility where non-fuel merchandise can be purchased).

The dispenser position 14 typically includes any one of various conventional equipment configurations enabling a customer to request and conduct a refueling transaction. Optionally, dispenser position 14 may be configured to enable the customer to make selections regarding the purchase of non-fuel merchandise and perform various other non-fuel related activities, such as connecting to the World Wide Web via an Internet connection so as to experience various services (e.g., accessing a personal e-mail account or making e-commerce purchases).

For purposes of communicating with network 12, the dispenser environment 10 is equipped with a suitable network connection or interface 16 to enable bi-directional communications with network 12. In a preferred form, network 12 preferably includes the Internet and the World Wide Web (WWW). By way of illustration, network 12 provides a connection or other such access between and among the various fuel dispenser environments 10 and also a connectivity involving any node(s) attached to network 12, such as servers 18, network resource 20, and remote dispenser site management facility 22.

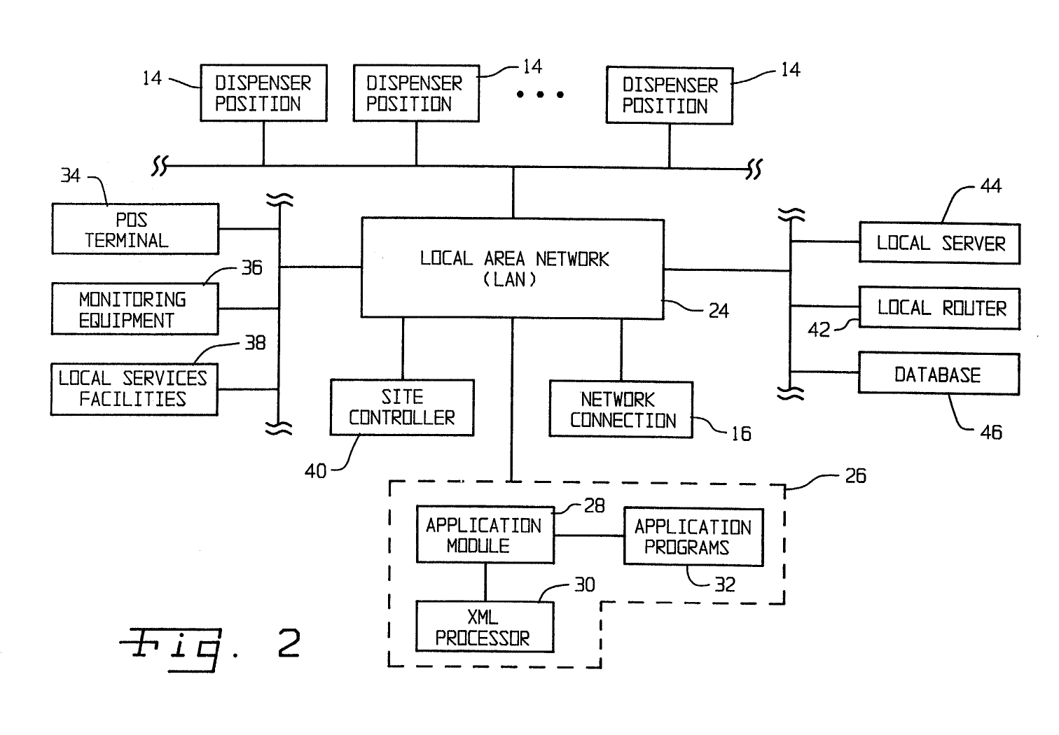

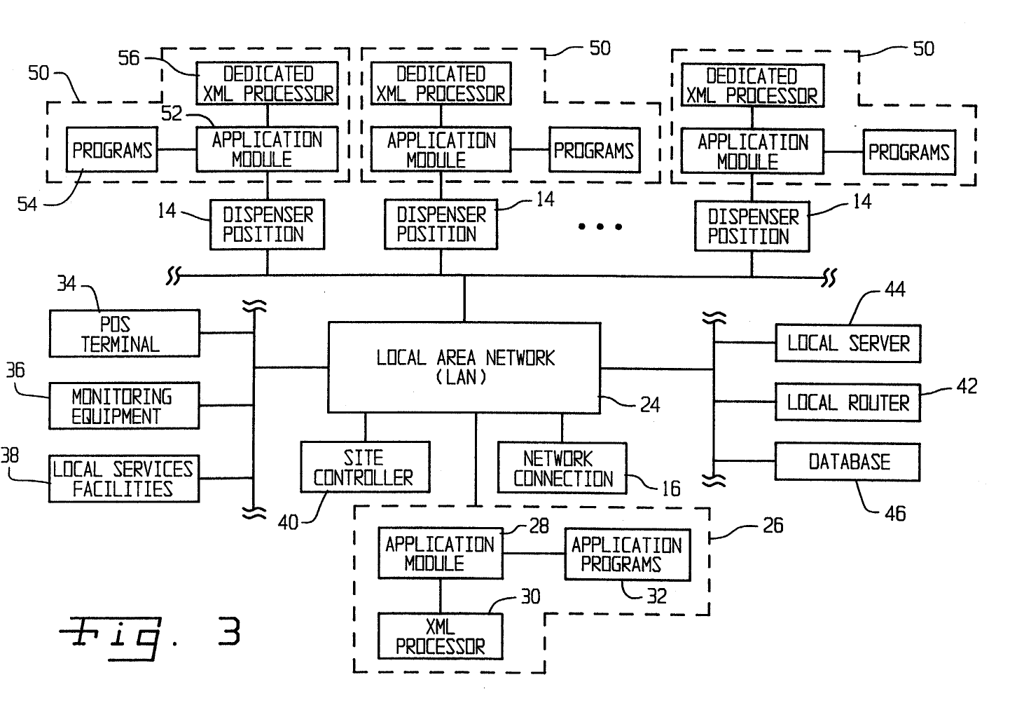

By way of overview, the present invention relates to the use of at least one XML processor in association with dispenser environment 10. In one form, as illustrated by FIG. 2, a centralized computing environment is developed that utilizes a central computing facility having the XML processors to handle the XML-related processing tasks for the entire dispenser environment 10. In another form, as illustrated by FIG. 3, a distributed, decentralized computing environment is developed that utilizes a dedicated XML processing module in conjunction with each dispenser position 14.

The XML processors are preferably associated with an application module that cooperatively interacts with the XML processors. In particular, the relationship between the application module and XML processors is similar to the conventional computing arrangement known to those skilled in the art involving the interaction between application processes (e.g., software programs) and processors. For example, the XML processors can be considered to perform their computing tasks and other such work (e.g., processing functions) on behalf of and in accordance with the application module, which may provide instructions and commands to the XML processors.

Among its various functions, as discussed below in further detail, the XML processors may be programmed to convert or otherwise transform non-XML data objects into XML documents. Similarly, the XML processor can transform XML documents into non-XML data objects. In particular, the XML processor is capable of reading XML documents and providing access to their content and structure, namely, retrieving the data elements (i.e., content) contained therein and understanding what they signify.

For example, the typical point-of-sale (POS) terminal installed in a conventional refueling location cannot understand, recognize, or otherwise handle signals having an XML format. Only signals having a specific format native to the POS terminal are acceptable. As used herein, this native format should be understood as defining the format, attributes, characteristics, communications protocol, interface specification, and other such description of a signal capable of being used or otherwise recognized by the corresponding device or process.

According to the present invention, however, any XML documents having information designated or otherwise intended for use by the POS terminal will be processed by the relevant XML processor to obtain the data objects contained therein. These data objects are then provided in a form native to the POS terminal. In particular, the data objects acquired by the XML processor from the document read operation are suitable for use by the POS terminal.

Similarly, any data objects (i.e., data signals) issuing from the POS terminal will be transformed by the relevant XML processor from their native format into XML documents. In effect, the data objects will be embedded, contained, embodied, or otherwise represented within the XML document, in a manner known to those skilled in the art.

It should be similarly understood that such data objects provided by the XML processor may be considered to define or otherwise represent signals usable by the fuel dispenser environment, signals suitable for use by the dispenser environment, signals readable by the dispenser environment, and signals compatible with the dispenser environment.

Moreover, it is a preferred feature of the XML processors that the content data elements obtained from an XML documents may be provided in any selectable format associated with the dispenser environment. For example, the format would be compatible with the operation of a particular device within the environment.

For this purpose, a suitable means or other such facility is provided that contains the native format specifications of all of the available, or otherwise accessible, components, applications, devices, processes, and other functional units of the dispenser environment. In this manner, the XML processor can provide the application module with the appropriately formed and constructed signal which is expressed in the native format corresponding to the designated end user. In particular, such a utility ensures that the data object generated by the XML processor and supplied to the application module conforms to the protocol or format requirements of the target device.

Furthermore, it may be considered that the write operation and read operation described above may be performed by the XML processor according to a formatting function known to those skilled in the art. In particular, the write operation processes the input data objects (e.g., POS signals) and produces an XML document incorporating the data objects, while the read operation processes an input signal expressed at least in part in an XML format (e.g., an XML document) and retrieves the data objects stored therein (e.g., control commands for the POS terminal).

It should be apparent that the examples and illustrations noted above (particularly those relating to the functionality of the XML processor) are provided for explanatory purposes only and should not be considered in limitation of the present invention, as the scope of the present invention may be considered to include other modifications, variations, and changes. For example, the XML processor may include functionalities and signal processing capabilities other than those mentioned above in relation to the formatting operations.

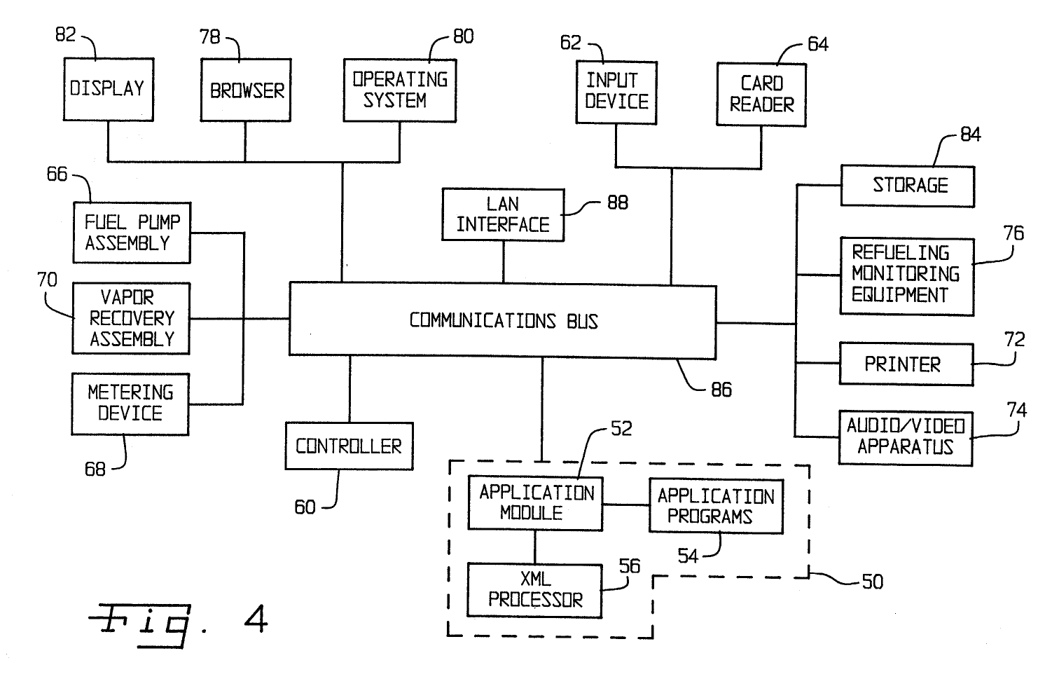

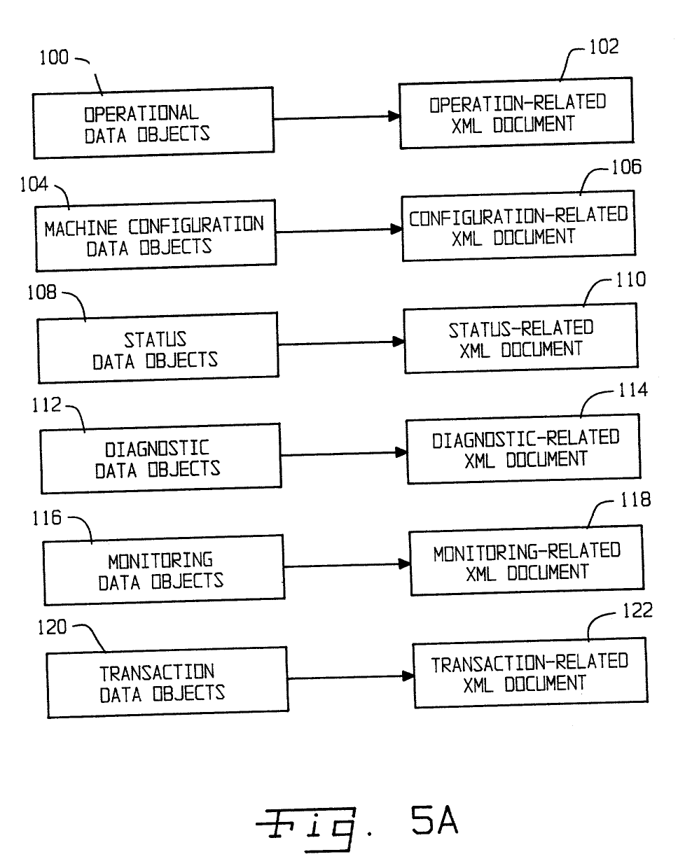

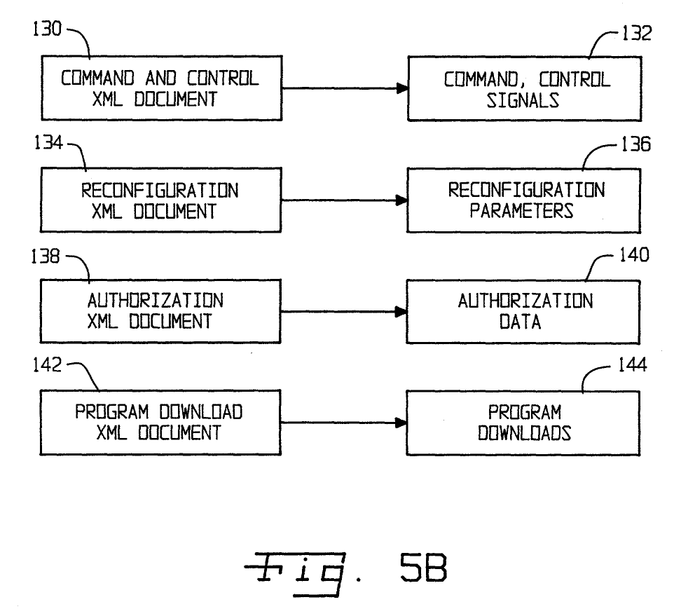

Further details of the structure and operation of the XML processor are made below in reference to FIGS. 4 and 5. However, reference is first made to FIGS. 2 and 3 to describe certain configurations of fuel dispenser environment 10 that implement the XML processor discussed herein, according to various embodiments of the present invention.

Referring to FIG. 2, there is shown a configuration for dispenser environment 10 according to one embodiment of the present invention.

The illustrated dispenser environment 10 includes a centralized operating module 26 that is connected to the multiple dispenser positions 14 using any suitable means, such as a local area network (LAN) 24. As discussed further, the illustrated operating module 26 includes an application module 28, application programs 32, and an XML processor 30.

In this configuration, the XML processing functionality for the entire dispenser environment 10 is centralized within a single facility, namely, operating module 26. By way of comparison, in FIG. 3, this XML processing functionality is implemented at each dispenser position 14 in the form of at least one dedicated XML processor. The advantage of such a centralized tasking platform for executing the XML-based processing functions is that little or no adaptations need to be made to each dispenser position 14.

It should be apparent that operating module 26 will be equipped with any suitable means needed to support its interoperability with dispenser positions 14 and any other devices. For example, software or other such means may be used to facilitate the multi-tasking capabilities of operating module 26, namely, the ability to perform in parallel the XML-based processing operations associated with the various dispenser positions 14.

It should also be apparent that operating module 26 is preferably equipped to handle the XML-based processing operations of any other devices or components resident at the refueling environment location, such as station operator or POS terminal 34, monitoring equipment 36, and local service facilities 38. In particular, XML processor 30 is capable of handling the XML processing duties associated with components and devices not affiliated with dispenser positions 14 but still part of the refueling environment location.

For example, monitoring data generated by monitoring equipment 36 and information associated with POS terminal 34 (e.g., customer requests and operator responses) can be processed by XML processor 30. In particular, customer requests could be encoded into an XML document and sent to an XML-based authorization terminal. Similarly, the monitoring data could be encoded into an XML document and uploaded to a remote maintenance facility. Likewise, operator responses could be encoded into an XML document to enable their transmission to another XML-compliant device in dispenser environment 14, such as a dedicated XML processor at the destination dispenser position 14 (FIG. 3).

Although single elements are shown for the respective components of operating module 26, this arrangement is provided for illustrative purposes only and should not be considered in limitation of the present invention, as it should be apparent that any number of such components may be utilized. For example, multiple XML processors may be used each dedicated to a particular function. Moreover, multiple application modules may also be used.

The illustrated dispenser environment 10 further includes a conventional dispenser controller 40 that manages in a multitasking manner the control requirements of the various dispenser positions 14. The dispenser environment 10 may also include a conventional site management capability enabling an on-site operator to communicate with any or all of the dispenser positions 14 using the appropriate terminal apparatus 34 or other POS equipment such as a PC-based workstation.

A suitable monitoring apparatus 36 may be used to collect various data on the status, performance, and operational condition of the fuel dispensing equipment (e.g., volumetric flow data rate measurements from the metering device). The monitoring equipment 36, for example, acquires data such as machine status, diagnostic results, and performance measurements. This monitoring data may be forwarded to XML processor 30 where it will be processed and encapsulated within an XML document.

The multiple dispenser positions 14 are preferably interconnected over LAN 24. For this purpose, each dispenser position 14 will be equipped with the appropriate network attachment device, driver software, and interface mechanisms. A local router or switch 42 may be optionally provided to handle the routing tasks associated with communications over LAN 24.

A local server 44 may be optionally provided to enable local content to be resident within the refueling environment. For this purpose, each dispenser position 14 may be configured as a client entity in order to establish a conventional client-server relationship with local server 44.

Additionally, a local database 46 may be integrated into the system and can be accessed over LAN 24 from any one of the dispenser positions 14 or from another node. Database 46, for example, may contain XML documents capable of being accessed and retrieved by any suitable facility, such as operating module 26 (i.e., XML processor 30) and/or dedicated XML processors at each dispenser position (FIG. 3).

Other local services and features may also be integrated within the refueling environment, as depicted generally by local service facilities 38. The dispenser positions 14 may gain access to local service facilities 38 via LAN 24.

Optionally, the auxiliary systems and other devices outside the individual dispenser positions 14 may each be configured with a dedicated XML processor similar to XML processor 30 in order to perform any device-specific XML processing operations.

Referring now to FIG. 3, there is shown a configuration for dispenser environment 10 according to another embodiment of the present invention.

The illustrated dispenser environment 10 implements an XML processing functionality at one, some, or all of the dispenser positions 14. More specifically, in one preferred form, each dispenser position 14 includes an operating module 50 similar to operating module 26 of FIG. 2. Each operating module 50 includes an application module 52, application programs 52, and a dedicated XML processor 56.

Although single elements are shown for the respective components of operating module 50, this arrangement is provided for illustrative purposes only and should not be considered in limitation of the present invention, as it should be apparent that any number of such components may be utilized. For example, multiple XML processors and multiple application modules may be used in connection with a respective operating module 50.

This configuration may optionally include the centralized operating module 26 of FIG. 3. This module 26, or any other such operating module not specifically affiliated with a particular dispenser position 14, may be used within dispenser environment 10 to perform tasks not contemplated by or reserved to the dedicated XML processors 56. For example, certain station-wide functions may be performed by these independent operating modules, such as providing centralized collection of monitoring data, compiling inventory and transaction history records, and receiving and distributing reconfiguration data.

Referring now to FIG. 4, there is shown one illustrative configuration of dispenser position 14 in FIG. 3 to facilitate an understanding of the present invention, specifically in connection with operating module 50.

By way of overview, the illustrated dispenser position 14 may include a conventional arrangement comprising controller 60 to manage the operations of the dispenser position, an input mechanism enabling a customer to make transaction and payment selections (i.e., input device 62 and card reader 64), and fuel dispensing equipment (i.e., fuel pump assembly 66, metering device 68, and vapor recovery assembly 70). Peripheral equipment may be included, such as printer 72 and audio/video apparatus 74 (e.g., an intercom system). Local monitoring equipment 76 may be provided to monitor the dispenser position components.

An enhanced communications feature may be added to dispenser position 14 that involves an Internet access capability implemented with browser 78 (e.g., Netscape Navigator™ or Microsoft Internet Explorer™) running on operating system 80 (e.g., Microsoft Windows™), for example. The computing platform for use with browser 78 and operating system 80 preferably includes a suite of applications software to perform various interactive tasks such as composing and transmitting e-mail messages, accessing e-mail accounts, word processing, document creation, document retrieval, and web site access to download page contents. A display or monitor 82 may be included, particularly in connection with the operation of browser 78.

There is optionally provided a storage facility 84 attached as a peripheral device within dispenser position 14. Storage 84 may serve as a dedicated storage medium for use with XML processor 56. In one form, storage 84 enables XML files generated by XML processor 56 to be archived for subsequent access and retrieval.

The various components and devices may be connected together over a conventional medium such as any suitable communications bus 86. A conventional LAN interface 88 is used to provide a connection with LAN 24.

The particular arrangement shown in FIG. 4 is provided for illustrative purposes only and should not be considered in limitation of the present invention, as it should be apparent that the present invention may be used in conjunction with other arrangements and operational features.

Turning now to a specific description of the operation of the present invention, reference is made to FIG. 5 in conjunction with FIG. 4. FIG. 5 illustratively depicts a representation of the various signals and XML documents that may be processed by XML processor 56 in connection with application module 52.

For purposes of clarity, FIG. 5 describes the encoding process (FIG. 5A) and decoding process (FIG. 5B) associated with a formatting function of XML processor 56.

Referring first to FIG. 5A, the encoding process performed by XML processor 56 involves the processing of various input data objects including, but not limited to, operational, configuration, status, diagnostic, monitoring, and transaction-related information. The encoding operation produces an XML document that is handled by application module 52. In particular, application module 52 includes various application programs 54 that direct the application functions conducted in relation to the XML documents.

For example, operational information 100 issuing from dispenser position 14, such as fuel pump dispensing rate (obtained from pump assembly 66), dispensed fuel volume (obtained from metering device 68), value of the dispensed fuel, and vapor recovery collection rate (obtained from assembly 70), may be encoded into one or various respective XML documents 102. In turn, application module 52 may designate the XML documents 102 for storage in a database, forwarding to POS terminal 34 for periodic review, uploading to a remote management facility for analysis, or handling by any other suitable application, for example.

Configuration information 104, including both fixed and variable parameters such as pump site number, blend ratios, unit price value, and settings for the fuel pump and vapor recovery apparatus (e.g., the flow rates to control pumping and vapor collection), may be encoded into one or various respective XML documents 106. In turn, application module 52 may designate the XML documents 106 for subsequent storage, processing, or handling by any other suitable application, for example.

Status information 108 provided in connection with determining a machine condition, such as whether a device is enabled or disabled (i.e., ON/OFF), error codes, and other error report occurrences, may be encoded into one or various XML documents 110. In turn, application module 52 may designate the XML documents 110 for subsequent storage, processing, or handling by any other suitable application, for example.

Diagnostic information 112 provided in response to executed diagnostic routines, such as error codes and machine state signals (e.g., power, current and voltage levels), may be encoded into one or various respective XML documents 114. In turn, application module 52 may designate XML documents 114 for subsequent storage, processing, or handling by any other suitable application, for example. XML documents 118 may also be prepared in conjunction with monitoring data 116.

Transaction information 120, such as customer-generated selections including refueling requests, refueling parameters and other control selections (e.g., fuel type, volume/dollar amount of purchase), and payment or other financial data (e.g., form of payment, credit card account number), may be encoded into one or various XML documents 122. Additionally, sales information such as total cost of completed transaction and total amount of fuel dispensed may be incorporated into an XML document. In turn, application module 52 may designate XML documents 122 for subsequent storage, processing, or handling by any other suitable application, for example.

It should be understood that the types of information indicated above, namely, dispenser-related information (i.e., operational, configuration, diagnostic, status, and monitoring data), transaction-related information (i.e., refueling control selections and payment data), and any merchandising information (such as data involving non-fuel related purchases), do not represent an exhaustive listing of all possible signals subject to XML processing and therefore should not be considered in limitation of the present invention. Rather, the present invention may include, without limitation, any other data, information, or other such signals for representation within an XML document.

Moreover, it should be apparent that all of the normal communications and functions that take place within and/or in connection with the fuel dispenser environment may be carried out using XML as the standard mechanism for describing and otherwise representing the data. For this purpose, each device, process, or unit within the dispenser environment that either receives or issues signals would be configured with an operating module having a suitable arrangement of application modules and XML processors.

It is especially notable that the present invention allows XML-based communications between and among the various dispenser positions 14, POS terminal 34 (FIGS. 2-3), server 18 (FIG. 1), and remote management facility 22 (FIG. 1).

Referring next to FIG. 5B, the decoding process performed by XML processor 56 involves the processing of input XML documents having content that includes any number and type of data elements. The decoding operation processes the XML document and retrieves the data elements contained therein. These retrieved data elements are then processed further by application module 52. In particular, application module 52 includes various application programs 54 that direct the application functions conducted in relation to the retrieved data elements.

An example illustrating both encoding and decoding application programs would be a fuel station having a site controller and fuel dispenser having XML processors and a POS terminal and kerosene dispenser not having XML processors. When the POS terminal activates all dispensers in the service station, the POS terminal sends one or more commands to the site controller. The site controller encodes the commands to produce an XML document so that the site controller can interpret the commands. The site controller sends the XML document to the fuel dispenser so that the fuel dispenser can be activated. Also, the site controller decodes the XML document so that the kerosene dispenser can interpret the commands and the kerosene dispenser can be activated.

The decoding process implemented by XML processor 56 may involve XML documents having content that includes, but is not limited to, command and control information, reconfiguration information, authorization data, and program downloads. These XML documents, for example, may be generated by a station operator terminal, remote management facility, or other such system that cooperates and otherwise interacts with the user and dispenser equipment to execute the refueling operation.

Command and control information may be expressed in an XML document 130 that is designated ultimately for receipt and use by the on-site dispenser controller. The XML processor 56 would decode the XML document 130 and provide the command and control signals 132 contained therein.

Examples of such command and control information may include, but is not limited to, data indicating a preset amount of fuel to dispense based upon customer selections; enabling/disabling signals (such as commands to initiate, terminate, suspend, and resume dispenser operation); data to control the fuel pump and vapor recovery flow rate settings; and requests or polling instructions to receive information such as machine status, monitoring data, current equipment configuration portfolios, and diagnostic data.

The XML document 130 would preferably include addressing information as one of its content data elements. In particular, the XML document may include the necessary data fields to designate where the other content is to be sent within the dispenser environment, i.e., the specific device or component. In this manner, the application module 52 can examine and evaluate the retrieved control data 132 and issue the corresponding control instructions to the proper dispenser equipment.

For this purpose, application module 52 will be equipped with suitable application programs 54 to facilitate the handling and management of such retrieved data objects. It may also be possible for application programs 54 to further process the retrieved data objects before proceeding with further tasks on the data within the dispenser environment.

It should be understood that operating module 50 will be equipped with any suitable means necessary to conform the data objects retrieved from the XML documents to the native format of the designated end user application. In particular, this facility will enable the retrieved data objects to be provided in a form compatible with the operating requirements of the specific dispenser device, component, process, or application to which it is being sent.

Reconfiguration information, such as commands or control data to adjust, vary, modify, or otherwise reset device parameters according to the refueling transaction request (e.g., amount or value of fuel to be dispensed), may be provided in an XML document 134. The XML processor 56 will decode XML document 134 and provide the corresponding data objects incorporating the reconfiguration parameters and instructions 136.

Authorization information, such as a control signal indicating authorization to proceed with the requested transaction, may be embedded within an XML document 138. The XML processor 56 will decode XML document 138 and provide the corresponding data objects incorporating the authorization instructions 140.

Additionally, program code downloads (such as software updates, driver routines, operating system revisions, application programming interface (API) routines, interface protocols, and browser software), may be embodied within an XML document 142 for purposes of downloading to the dispenser location to update the relevant programs. The XML processor 56 will decode XML document 142 and provide the corresponding data objects incorporating the program download information 144.

It should be understood that the types of information indicated above, namely, command and control information, authorization information, and program code downloads, do not represent an exhaustive recitation of all possible signals that may be expressed in XML format and decoded by XML processor 56, and therefore should not be considered in limitation of the present invention. Rather, the present invention may include, without limitation, any other data, information, or other such signals for representation within an XML document for purposes of decoding at the dispenser site.

It should also be understood that the decoding operation performed by XML processor 56 will be widely used in those configurations of dispenser environment 10 that involve formatting all of the intra-dispenser signal communications in an XML document structure.

Although XML processor 56 has been described above in relation to its formatting function, this was merely illustrative and should not be considered in limitation thereof, as it should be understood that XML processor 56 can perform various other processing functions. For example, XML processor 56 can execute a validating function, a transforming function, a rendering function, and a transporting function.

The validating function ensures that XML documents are in fact valid. By way of background, a data entity is an XML document if it is well-formed, as defined by the specification. A well-formed XML document may also be valid if it meets certain additional constraints. An XML document is valid if it has an associated Document Type Definition (DTD) or XML Schema and if the document complies with the constraints expressed in it. XML DTD and XML Schema are standard mechanisms for defining the constraints on a specific class of XML documents. Either one provides the XML processor with the means to validate and interpret individual XML documents. The XML documents discussed herein may optionally include an appropriate DTD.

The transforming function will transform XML documents into other XML documents. Common transformations include, but are not limited to, sorting, filtering and numbering or ranking items.

The transporting function allows structured and typed information to be exchanged between peers in a decentralized, distributed environment using XML. These functions allow the XML documents to be used in a variety of applications including messaging systems and remote procedure calls.

The rendering function allows for multiple different presentations of XML documents. The different presentations are tailored to the output platform capability. For example, a presentation for a printer is typically rendered differently than for a graphical display. User preferences can also affect presentation choices. The simultaneous presentation of diagnostic data in tabular and graphical forms, for example, could be accomplished with the rendering function. Generally, the rendering function can create presentations for any hypertext-enabled application and device.

Other examples of rendering functions include an XML to HTML translation that converts an XML document into an HTML document for use by the typical browser. Typical locations for a browser in the refueling environment would include the user interface on the dispenser and remote access to a web server for system configuration. Appropriate style sheets such as Extensible Style Language (XSL) and Cascading Style Sheets (CSS) may be used to present the data in a browser.

Another rendering function is an XML to Scalable Vector Graphics (SVG) translation that converts XML into SVG for use in graphical displays. SVG is a language for describing two-dimensional vector and mixed vector/raster graphics in XML. An XML into Adobe Portable Document Format (PDF) translation converts XML into PDF for high-quality print-optimized documents. An XML into speech translation converts XML into speech in order to convey instructions or information.

Any conventional means may be used to implement the XML processor and/or application module. For example, a software module, logic module, or program code module such as a text editor or a scripting mechanism can be utilized. The implementation preferably utilizes a microprocessor-based computing platform.

One advantage feature of the present invention concerns the remote connectivity between the fuel dispenser environment 10 and a remote entity such as remote management facility 22 (FIG. 1) or any of the other remote nodes connected to network 12. In general, this remote connectivity allows XML files generated at a dispenser position 14 (e.g., dedicated processor 56) to be uploaded to remote management facility 22. Similarly, XML documents resident at a remote site may be downloaded to the refueling environment for use by any one or several of the dispenser positions 14. For example, remote documents (such as web pages formatted in XML) may be retrieved from a server and then downloaded to the dispenser environment 10 over the Internet.

Communications based upon the types of information described herein will be conducted in a seamless manner in which the XML processing will preferably appear transparent to the customer, station operator, and remote management facility.

Further information on XML may be found at the Internet address http://www.w3.org, the web site for the World Wide Web Consortium (W3C) (particularly in reference to the Extensible Markup Language 1.0 specification); the Internet address http://www.sun.com, the web site for Sun Microsystems; the Internet address http://msdn.microsoft.com/xml. a web site of Microsoft Corporation of Redmond, Wash., and the Internet address http://www.xml.com, the contents of each being incorporated herein by reference thereto.

What has been shown and described herein is an improved method of describing, communicating, manipulating, and presenting structured data in the fueling environment using XML. Data in the form of, but not limited to, configuration parameters, command sets, and financial transactions may be easily described using XML and XML-based vocabularies. Once described, the data is communicated, manipulated, or presented using the family of supporting XML vocabularies and technologies.

Examples of the benefits of using XML include:

(1) the XML structured data is described in a uniform manner independent of applications or vendors;

(2) communication with XML documents is made easier because processing power is not allocated to accommodating and overcoming differences in platform, operating systems, language, or data stores;

(3) availability of standard mechanisms for transporting XML, such as SOAP (simple Object Access Protocol), which is an XML based object protocol for the exchange of information in a decentralized, distributed environment;

(4) the use of Document Object Model (DOM), which is a defined standard for programmatically accessing the structure and data contained within an XML document, and the use of SAX (Simple API for XML) specification to enable event-drive parsing of an XML document; and

(5) the availability of style sheets such as XSL and CSS as standard mechanisms for manipulating and presenting XML documents.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system, comprising:
a refueling system comprising at least one fuel dispenser environment;
at least one processor, each processor being associated with a respective fuel dispenser environment;
each processor having an Extensible Markup Language (XML) signal processing capability.

2. The system as recited in claim 1, further comprises:
at least one application module, each application module being associated with a respective fuel dispenser environment, each application module being cooperatively associated with at least one of the at least one processor of the fuel dispenser environment associated therewith, each application module being configured to operatively perform at least one application function in relation to the fuel dispenser environment associated therewith.

3. The system as recited in claim 1, wherein each processor respectively comprises at least one of:
an encoder process configured to encode at least one input signal received from the respective fuel dispenser environment associated therewith into at least one output XML document; and
a decoder process configured to decode at least one input XML document and produce therefrom at least one output signal representative of at least one data signal embodied within the at least one input XML document, wherein at least one of the at least one output signal being readable by the respective fuel dispenser environment associated therewith.

4. The system as recited in claim 1, further comprises:
at least one network connection, each network connection being associated with a respective fuel dispenser environment, each network connection being configured for operative communication with at least one respective processor of the respective fuel dispenser environment.

5. The system as recited in claim 4, further comprises:
a network arranged in operative communication with said refueling system.

6. The system as recited in claim 5, wherein said network includes the Internet.

7. The system as recited in claim 1, wherein the XML signal processing capability of each respective processor enabling the performance of functions comprising at least one of:
receiving at least one input data object from the respective fuel dispenser environment associated therewith,
expressing the at least one input data object as at least one output XML document,
receiving at least one input XML document, and
processing the at least one input XML document to provide at least one output data object derived therefrom, wherein at least one of the at least one output data object being readable by the respective fuel dispenser environment associated therewith.

8. The system as recited in claim 7, wherein the input data objects associated with a respective fuel dispenser environment comprising signals including at least one of operational information, configuration information, status information, diagnostic information, refueling transaction information, financial information, and point-of-sale (POS) information.

9. The system as recited in claim 7, wherein the output data objects associated with a respective fuel dispenser environment comprising signals including at least one of commands, operating instructions, control information, reconfiguration information, authorization information, sale information, and program code downloads.

10. The system as recited in claim 7, wherein the input data objects associated with a respective fuel dispenser environment comprising signals generated by at least one of a dispenser controller, fuel pump assembly, fuel metering device, vapor recovery assembly, user input device, display assembly, card reader, printer, fuel monitoring equipment, audio apparatus, video apparatus, and communications apparatus.

11. The system as recited in claim 7, wherein the output data objects associated with a respective fuel dispenser environment comprising signals readable by at least one of a dispenser controller, fuel pump assembly, fuel metering device, vapor recovery assembly, user input device, display assembly, card reader, printer, fuel monitoring equipment, audio apparatus, video apparatus, and communications apparatus.

12. A system, comprising:
at least one fuel dispenser environment; and
at least one application module, each application module being associated with a respective fuel dispenser environment;
each application module including at least one processor each having an Extensible Markup Language (XML) signal processing capability.

13. The system as recited in claim 12, wherein each processor respectively comprises at least one of:
an encoder process configured to encode at least one input signal received from the respective fuel dispenser environment associated therewith into at least one output XML document; and
a decoder process configured to decode at least one input XML document and produce therefrom at least one output signal representative of at least one data signal embodied within the at least one input XML document, wherein at least one of the at least one output signal being readable by the respective fuel dispenser environment associated therewith.

14. The system as recited in claim 12, wherein each application module being configured to operatively perform at least one application function in relation to the fuel dispenser environment associated therewith.

15. The system as recited in claim 14, wherein each application module being operable to perform the application functions associated therewith using data objects derived from XML documents and/or signals having an XML format, as provided by the at least one processor associated therewith.

16. The system as recited in claim 12, wherein the input signals associated with a respective fuel dispenser environment comprising signals including at least one of operational information, configuration information, status information, diagnostic information, refueling transaction information, financial information, and point-of-sale (POS) information.

17. The system as recited in claim 12, wherein the output signals associated with a respective fuel dispenser environment comprising signals including at least one of commands, operating instructions, control information, reconfiguration information, authorization information, sale information, and program code downloads.

18. The system as recited in claim 12, wherein the input signals associated with a respective fuel dispenser environment comprising signals generated by at least one of a dispenser controller, fuel pump assembly, fuel metering device, vapor recovery assembly, user input device, display assembly, card reader, printer, fuel monitoring equipment, audio apparatus, video apparatus, and communications apparatus.

19. The system as recited in claim 12, wherein the output signals associated with a respective fuel dispenser environment comprising signals readable by at least one of a dispenser controller, fuel pump assembly, fuel metering device, vapor recovery assembly, user input device, display assembly, card reader, printer, fuel monitoring equipment, audio apparatus, video apparatus, and communications apparatus.

20. The system as recited in claim 12, wherein the XML signal processing capability of each respective processor enabling the performance of functions comprising at least one of:
receiving at least one first input signal from the respective fuel dispenser environment associated therewith,
expressing the at least one first input signal as at least one first output signal provided at least in part in an XML format,
receiving at least one second input signal expressed at least in part in an XML format, and
processing the at least one second input signal to provide at least one second output signal derived therefrom, wherein at least one of the at least one second output signal being readable by the respective fuel dispenser environment associated therewith.

21. The system as recited in claim 12, further comprises:
at least one network connection, each network connection being associated with a respective fuel dispenser environment, each network connection being configured for operative communication with at least one respective application module of the respective fuel dispenser environment.

22. The system as recited in claim 21, further comprises:
a network arranged in operative communication with the respective network connection of at least one fuel dispenser environment.

23. An apparatus, comprising:
at least one fuel dispenser environment; and
at least one Extensible Markup Language (XML) processor, each XML processor being associated with a respective fuel dispenser environment.

24. The apparatus as recited in claim 23, wherein each XML processor respectively comprises at least one of:
a data object encoder process; and
an XML document decoder process, wherein at least one of the decoded signals produced by the XML document decoder process being compatible with the respective fuel dispenser environment associated therewith.

25. The apparatus as recited in claim 23, wherein each XML processor respectively comprises at least one of:
a first data process configured to provide at least one output signal in an XML format, using at least one signal received from the respective fuel dispenser environment associated therewith, and
a second data process configured to process at least one input signal having an XML format and provide at least one output signal derived therefrom, wherein at least one of the at least one output signal provided by the second data process being readable by the respective fuel dispenser environment associated therewith.

26. The apparatus as recited in claim 23, further comprises:
at least one network connection, each network connection being associated with a respective fuel dispenser environment, each network connection being configured for operative communication with at least one respective XML processor of the respective fuel dispenser environment.

27. An apparatus, comprising:
at least one fuel dispenser environment; and
at least one application module, each application module being associated with a respective fuel dispenser environment;
each application module including at least one Extensible Markup Language (XML) processor.

28. The apparatus as recited in claim 27, wherein each XML processor respectively comprises at least one of:
a data object encoder process; and
an XML document decoder process, wherein at least one of the decoded signals produced by the XML document decoder process being compatible with the respective fuel dispenser environment associated therewith.

29. The apparatus as recited in claim 27, wherein each application module being configured to operatively perform at least one application function in relation to the fuel dispenser environment associated therewith.

30. A system, comprising:
at least one fuel dispenser environment;
at least one processor, each processor being associated with a respective fuel dispenser environment;
each processor respectively comprising at least one of:
a data process configured to provide at least one output Extensible Markup Language (XML) document, using at least one input signal received from the respective fuel dispenser environment associated therewith, and
a data process configured to process at least one input XML document and provide at least one output signal derived therefrom, wherein at least one of the at least one output signal being readable by the respective fuel dispenser environment associated therewith.

31. A system, comprising:
at least one fuel dispenser environment;
at least one processor means, each processor means being associated with a respective fuel dispenser environment;
each processor means respectively comprising at least one of:
a means, responsive to at least one input signal received from the respective fuel dispenser environment associated therewith, for generating at least one Extensible Markup Language (XML) document, using the at least one input signal as content, and
a means, responsive to at least one input XML document, for processing the at least one input XML document to produce at least one output signal derived therefrom, wherein at least one of the at least one output signal being readable by the respective fuel dispenser environment associated therewith.

32. A system, comprising:
at least one fuel dispenser environment;
at least one processor, each processor being associated with a respective fuel dispenser environment;
each processor respectively comprising at least one of:
a first data process configured to provide at least one output signal expressed at least in part in an Extensible Markup Language (XML) format, using at least one signal received from the respective fuel dispenser environment associated therewith, and
a second data process configured to process at least one input signal expressed at least in part in an XML format and to provide at least one output signal derived therefrom, wherein at least one of the at least one output signal provided by the second data process being readable by the respective fuel dispenser environment associated therewith.

33. A system, comprising:
at least one fuel dispenser environment;
at least one processor, each processor being associated with a respective fuel dispenser environment;
each processor respectively comprising at least one of:
an encoder process configured to encode at least one input signal received from the respective fuel dispenser environment associated therewith into at least one output Extensible Markup Language (XML) document, and
a decoder process configured to decode at least one input XML document and provide at least one output signal derived therefrom, wherein at least one of the at least one output signal being readable by the respective fuel dispenser environment associated therewith.

34. A system, comprising:
at least one fuel dispenser environment;
at least one processor means, each processor means being associated with a respective fuel dispenser environment;
each processor means respectively comprising at least one of:
a means, responsive to at least one input signal received from the respective fuel dispenser environment associated therewith, for encoding the at least one input signal into at least one Extensible Markup Language (XML) document, and
a means, responsive to at least one input XML document, for decoding the at least one input XML document to produce at least one output signal derived therefrom, wherein at least one of the at least one output signal being readable by the respective fuel dispenser environment associated therewith.

35. A system, comprising:
at least one fuel dispenser environment;
at least one processor, each processor being associated with a respective fuel dispenser environment;
each processor respectively comprising at least one of:
an encoder process configured to encode at least one signal received from the respective fuel dispenser environment associated therewith into at least one output signal expressed at least in part in an Extensible Markup Language (XML) format, and
a decoder process configured to decode at least one input signal expressed at least in part in an XML format and provide at least one output signal derived therefrom, wherein at least one of the at least one output signal provided by the second data process being readable by the respective fuel dispenser environment associated therewith.

36. A method for use in a fuel dispenser environment, said method comprising the steps of:
receiving at least one input signal issuing from the fuel dispenser environment;
processing the at least one input signal to generate at least one Extensible Markup Language (XML) document incorporating the at least one input signal;
receiving at least one input XML document; and
processing the at least one input XML document to provide at least one output signal representative of at least one signal embodied within the at least one input XML document, wherein at least one of the at least one output signal being readable by the fuel dispenser environment.

37. The method as recited in claim 36, further comprises the steps of:
providing at least one application process, each application process being configured to operatively perform at least one application function in relation to the fuel dispenser environment; and
executing at least one application function, using at least one output signal provided by the input XML document processing step.

38. A method for use in a fuel dispenser environment, said method comprising the steps of:
encoding at least one input signal issuing from the fuel dispenser environment into at least one Extensible Markup Language (XML) document; and
decoding at least one input XML document to produce at least one output signal representative of at least one data signal embodied within the at least one input XML document, wherein at least one of the at least one output signal being readable by the fuel dispenser environment.

39. The method as recited in claim 38, further comprises the steps of:
providing at least one application process, each application process being configured to operatively perform at least one application function in relation to the fuel dispenser environment; and
executing at least one application function, using at least one output signal provided by the decoding step.

40. A system, comprising:
at least one fuel dispenser environment, each fuel dispenser environment including at least one device;
at least one Extensible Markup Language (XML) processor, each XML processor being associated with a respective fuel dispenser environment device.

41. A system, comprising:
at least one fuel dispenser environment, each fuel dispenser environment including at least one device; and
at least one application module, each application module being associated with a respective fuel dispenser environment device;
each application module including at least one Extensible Markup Language (XML) processor.
